(19) United States
(12) Patent Application Publication
(10) Pub. No.: US 2006/0194918 A1
(43) Pub. Date: Aug. 31, 2006

(54) Novel adhesives comprising diacetals

(76) Inventors: Antonio Pizzi, Chantraine (FR); Philippe Faucher, La Celle Saint Cloud (FR); Michela Zanetti, Knoxville, TN (US)

Correspondence Address: BROWDY AND NEIMARK, P.L.L.C.;624 NINTH STREET, NW, SUITE 300, WASHINGTON, DC, 20001-5303, US

(21) Appl. No.: 10/529,253

(22) PCT Filed: Sep. 15, 2003
(86) PCT No.: PCT/FR03/02716

§ 371 Date: Dec. 7, 2005

(30) Foreign Application Priority Data
Sep. 25, 2002 (FR) 02/11845
Jul. 9, 2003 (FR) 03/08393

(51) Int. Cl. C03C 25/26

(52) U.S. Cl. 524/593

(57) ABSTRACT

A glue with high-mechanical resistance, comprising a diacetal which is linear or cyclic, which can be prepared from C₂-C₆ aldehydes and C₁-C₁₂ alcohols from agricultural waste, compositions of wood, papers or stratified cardboard containing said resin or glue or prepared using said glue and products prepared with the aid of said paper or stratified cardboard, and a method for glueing mineral fibres wherein the fibres are glued with the aid of a resin or the above-mentioned glue.

The present invention relates to novel adhesives containing diacetals and their uses.

Better adhesives are always being sought, which provide good mechanical strength when gluing.

EP-A-1 174 480 describes aminoresin or phenolic resin adhesives containing a C₁-C₆ alcohol acetal and their use in the production of wood particle boards. Examples are given of two monoacetals, namely methylal and ethylal.

FR-A-1 576 716 describes phenolic resin adhesives containing a C₁-C₈ alcohol acetal used in particular for the production of ligneous materials.

In the related field of paper and in particular products made of laminated paper (decorative laminate, decor sheet), many resins are used, for example melamine-formaldehyde, phenol-formaldehyde resins, as described in WO-A-97/00172, or WO-A-01/45940.

EP-A-1 225 278 describes a method for impregnating decorative paper using a melamine resin, and papers thus produced.

Phenolic resins are also well known for their use in the preparation of the binding agents for products based on mineral fibres, as described in EP-A-406498.

Now, the applicant has just discovered that the use of certain acetals, preferably diacetals, and particularly 1,1,2,2-tetramethoxyethane (hereafter TME) gives the resins and adhesives an exceptional strength, while being easier to handle industrially, because of their boiling temperatures and flash point.

This is why a subject of the present invention is an adhesive characterized in that it contains a diacetal which is linear or cyclic, being able to be prepared from C₂-C₆ dialdehydes and C₁-C₁₂ alcohols.

In the present application and in the following, the term “adhesive” designates the compounds usually called “adhesives” or “resins”.

By “diacetal”, is meant the compounds being able to be prepared from dialdehydes and alcohols but also the compositions which can combine structures of the diacetal, monoacetal and hemiacetal type.

Also by “diacetal”, is meant the compounds being able to be prepared from dialdehydes and polyols such as glycerol or pentaerythrol which lead to acetal compounds but also to compositions which can combine structures of the diacetal, monoacetal and hemiacetal type.

Under preferred conditions for implementation of the invention, the adhesive contains a diacetal, and more particularly 1,1,2,2-tetramethoxyethane.

The diacetals which can be used in the present invention can be prepared from C₂-C₆ aldehydes and C₁-C₁₂ alcohols, preferably from C₂-C₄ aldehydes and C₁-C₈ alcohols, and more particularly from C₂-C₃ aldehydes and C₁-C₃ alcohols.

By way of example, the diacetals can be 1,1,2,2-tetramethoxyethane (TME), 1,1,2,2-tetraethoxyethane (TEE), 1,1,2,2,-tetrapropoxyethane (TPE), 1,1,3,3-tetramethoxypropane (TMP), 1,1,3,3-tetraethoxypropane (TEP) and preferably TME.

In an adhesive according to the invention any combination of the aforementioned acetals can be used, for example 2 or 3 acetals, or 4 or more.

The aldehydes from which the acetals can be prepared which can be used according to the present invention are for example dialdehydes such as glyoxal, malonaldehyde, glutaraldehyde.

The alcohols from which the acetals can be prepared which can be used according to the present invention are for example monoalcohols such as methanol, ethanol, diols such as ethylene glycol, diethylene glycol, 1,4-butanediol, neopentylglycol or polyols such as glycerol or pentaerythrol.

For example it is considered that a diacetal such as TME can be prepared from glyoxal and methanol.

The adhesive can for example be an aminoresin adhesive, such as of the urea-resorcinol-formaldehyde, melamine-urea-phenol-formaldehyde, urea-formaldehyde type, preferably melamine-formaldehyde and particularly of the melamine-urea-formaldehyde type.

It can be also a phenolic resin adhesive such as a phenol-urea-formaldehyde adhesive and preferably resorcinol-phenol-formaldehyde or phenol-formaldehyde.

The adhesives based on resorcinol can also be mentioned such as tannin-resorcinol-formaldehyde or lignin-resorcinol-formaldehyde adhesives.

The aminoresin, phenolic resin or resorcinol adhesives without formaldehyde such as the adhesives of the following types: urea-dimethoxyethanal, ethylene urea-dimethoxyethanal, dihydroxyethylene urea-dimethoxyethanal, melamine-dimethoxyethanal-polyols in which the polyol is for example dipropylene glycol, glycerol tripropoxylate or polyvinyl alcohol, melamine-urea-dimethoxyethanal-polyols such as melamine-dimethoxyethanal-glycerol or melamine-dimethoxyethanal-dipropyleneglycol-glyceroltriethoxylate or also melamine-dimethoxyethanal or finally phenol-dimethoxyethanal, resorcinol-dimethoxyethanal and phenol-resorcinol-dimethoxyethanal can also be mentioned. These aminoresin and phenolic resin adhesives are marketed by CARIANT (France) in its Highlink® range.

Under preferred conditions for implementation of the invention, an aminoresin adhesive with formaldehyde or a phenolic resin adhesive is used.

Under other preferred conditions for implementation of the invention:
in the case of aminoresin adhesives, these are based on a nitrogen compound/formaldehyde mixture, preferably in proportions of 1/0.2 to 3, in particular 1/1.3 to 1.6, particularly approximately 1/1.5.
in the case of phenolic resin adhesives, these are based on a phenol/formaldehyde mixture, preferably in proportions of 1/0.7 to 2.8, in particular 1/1.5 to 1.8, particularly approximately 1/1.7.

The acetals can represent for example from 1.7 to 25% by weight of all of the constituents of the adhesive, preferably from 1.7 to 20%, in particular from 3 to 18%, particularly from 5.5 to 15%.

The resins and adhesives according to the present invention containing diacetals, particularly TME, have remarkable properties illustrated below in the experimental part.

The diacetals that they contain for example reduce the viscosity and the surface energy of the resins and adhesives according to the present invention, which results in particular in a better impregnation capacity of the substrates. Consequently, an improved resistance of the gluing carried out is observed. For this reason, it is possible to appreciably reduce the quantities of adhesive used in order to obtain the same resistance of the gluing.

Moreover, the resins and adhesives according to the invention release little formaldehyde.

Moreover, certain acetals have a high boiling temperature and flash point.

For example TME has a boiling temperature of 156° C. and a flash point of 50° C., which in particular distinguishes it from lower monoacetals such as methylal, the boiling temperature of which is 42.3° C. and the flash point −18 C. It is therefore considerably easier to use industrially and to transport.

Besides the fact that it is not toxic, it does not tend to evaporate much when it is used. In this regard it should be noted that within the scope of uses as binding agent for the production of particle boards, the shavings of mixed wood are at a temperature of 30 to 50° C., often approximately 40° C., which causes substantial losses of the volatile acetals by evaporation during production.

Moreover, the addition of a diacetal allows stabilization of the resins and adhesives, in particular of the phenolic resin type particularly of the phenol-formaldehyde type.

These properties justify the use of the resins and adhesives according to the invention in the production of ligneous materials: agricultural waste and wood such as wood fibreboards, particle boards, oriented strand boards or OSB, medium and high density fibreboards or MDF, and other types of similar boards and plywoods.

This is why a subject of the present application is also agricultural waste and wood compositions such as fibreboards, particle boards, “Oriented Strand Boards” (OSB), “Medium and High Density Fibreboards” (MDF), and other types of similar boards and plywoods containing a resin or adhesive as above or prepared using a resin or adhesive as above.

The subject of the present application is also a method for the production of agricultural waste and wood compositions such as fibreboards, particle boards, “Oriented Strand Boards” (OSB), “Medium and High Density Fibreboards” (MDF), and other types of similar boards and plywoods characterized in that it comprises the stages of mixing the substrate to be bound with an adhesive as above and curing the finished product.

These properties also justify the use of the adhesives and resins according to the invention in the production of impregnable substrates including paper or laminated board and in particular decor sheets or decorative laminates.

In a standard manner, the production of laminates using thermo-setting resins is carried out by impregnation of a paper support with different resins, for example phenolic or based on melamine, then drying and cutting. After drying and cutting, the coated (preimpregnated) papers are piled up and stored. The laminating phase allows, by piling up of these sheets and hot pressing, to finish the reaction of the resins and thus obtain the final product. There are also methods which combine, after impregnation, drying and laminating.

This is why the subject of the present application is also paper or laminated boards containing a resin or adhesive as above or prepared using a resin or adhesive as above, as well as wood-based materials covered with such papers or laminated board, by self-adhesive pressing under pressure or by gluing using an adhesive, such as for example fibreboards, particle boards, medium and high density fibreboards or MDF, and other types of similar boards and plywoods.

A subject of the present application is also products prepared using such papers or laminated boards as counter tops for the kitchen, bathroom or laboratory, or flooring.

The resins and adhesives described above are also well suited to spraying and have good dilutability in water and thus have applications in the preparation of compositions for adhesive or binding agents for products based on mineral fibres, such as glass fibres, intended for heat or sound insulating materials, or for layers of glass fibre intended for the reinforcement, for example, of products for roofs or plastic materials.

The binding agents which generally contain other adjuvants such as silanes, mineral oils or nitrogen compounds can be applied to the fibres according to traditional methods, for example by spraying. Then, the thus-treated fibres are usually subjected to a heat treatment in order to polycondense the resin and obtain a product presenting desired properties such as dimensional stability, tensile strength, moisture resistance.

This is why a subject of the present application is also a method for gluing mineral fibres in which the fibres are glued by a standard method such as spraying, using a resin or adhesive as above.

Finally, in a general way, a subject of the invention is the use of a diacetal as above in an adhesive or resin or for the preparation or the use of an adhesive or resin.

For this purpose, in particular said adhesive or resin can be mixed with elements to be bound together or a layer of adhesive or resin can be placed between two surfaces to be glued together. The present invention is not however aimed at a surface coating.

The preferred conditions for use of the resins and adhesives described above also apply to the other subjects of the invention aimed at above, in particular to agricultural waste and wood compositions and to paper or laminated board as well as their preparation methods.

The following examples illustrate the present invention.

In the present application and in the following, the term “parts” signifies “parts by weight”, “%” signifies “% by weight”.

### EXAMPLE 1

### Preparation of an Adhesive of the Aminoresin Type

An aminoresin adhesive was prepared according to the invention as follows:

71 parts of formurea (concentrate of formaldehyde stabilized with urea, containing 54% formaldehyde and 23% urea) is introduced into a flask equipped with a condenser, a thermometer and a pH meter, to which 8.2 parts of urea and 19 parts of water are added. The pH is adjusted to a value comprised between 10 and 10.4 by adding a few drops of a solution of sodium hydroxide at 33%, and the temperature is taken to 92-93° C. under mechanical stirring. The pH decreases to a value of 7.8 and the reaction continues at the same temperature until the pH falls to a value of 5.2 over approximately 1 hour 30 minutes. Then a few drops of solution of sodium hydroxide at 33% then 40 parts of melamine and 2 parts of dimethylformamide are added to the mixture, maintaining the temperature at 93° C. The water tolerance is tested every 10 minutes and the pH falls by itself. When the water tolerance is 180%-200% (normally after 35-40 minutes and at a pH value of 7.2), 21.4 parts of urea are added and the pH is adjusted to 9.5. The reaction continues until a water tolerance is reached which must never be less than 150% (the pH has a value of 7.7 at this point). The pH is corrected to a value of 9.5 and the mixture is cooled down and stored. A resin produced according to this procedure has a solid content of 58% to 65%, a density of 1.260 to 1.280 at 20° C., a viscosity of 70 to 150 MPa·s, a gel time of 55 to 60 s at 100° C. with 3% hardener (ammonium sulphate).

5 parts of TME and 3 parts of a solution of ammonium sulphate at 50% are added to 100 parts of the above melamine-urea-formaldehyde adhesive, in order to obtain an adhesive according to the invention.

The water tolerance test was carried out as follows: 1 g of resin was placed in a test tube and distilled water was added until the mixture became white. The water tolerance WT was produced by applying the formula
WT=(mass of water/mass of resin)×100

### EXAMPLE 2

### Preparation of an Adhesive of the Phenolic Resin Type

A phenolic resin adhesive (phenol-formaldehyde) according to the invention was prepared as follows:

94 parts of phenol, 40 parts of a methanol/water solution (20/80) and 55 parts of paraformaldehyde at 96% are placed in a flask equipped with a condenser, a thermometer, a pH meter and a mechanical stirrer. After 30 minutes of mechanical stirring at 40° C., the temperature is slowly taken to reflux (94° C.). 20 parts of a solution of sodium hydroxide at 33% are added in 4 equal parts at 15 minute intervals. The mixture is left under reflux for 30 to 60 minutes and cooled down in an ice bath. The colour of the resin is pale yellow and its viscosity is situated between 180 and 750 MPa·s, corresponding to a solid content of 58 to 60%. 10 parts of TME and 5 parts of a solution of triacetine at 99% are added to 100 parts of the phenol-formaldehyde adhesive prepared above in order to obtain an adhesive according to the invention.

Mechanical Tests

1) Thermomechanical Analysis (TMA)

Two small panels of beech wood were joined using the adhesive to be analyzed.

Operating Protocol

The principle of this method is based on a system of modelling the pressing of boards obtained by assembling two small panels using the adhesive to be analyzed, the quality of the assembly obtained being directly linked to that of the adhesive mixture used. More particularly, 30 mg of adhesive mixture are placed between two small panels of beech wood, and the assembly thus obtained is arranged on a support so that said assembly is supported by its two ends, and the whole is placed in an oven. The oven is subjected to a program of increasing the temperature from 25 to 250° C., at a rate of 10° C./min, which leads to a curing of the adhesive between the two small panels, and to the formation of a single small panel of solid wood. During the increase in temperature, a force is applied vertically (F=30 g) to the middle of the small panel, this force inducing a bending (b) which allows the modulus of elasticity to be determined. This bending (b) decreases as a function of the temperature, demonstrating an increase in mechanical strength. The apparatus used in this experiment is a METTLER TMA 40 thermomechanical analyzer, connected to a processor and to a computer allowing recording of the thermograms and the processing of the data obtained. More particularly, and for each sample tested, the deflection (b in μm) was measured as a function of the temperature, and the modulus of elasticity (E in MPa) was calculated according to the equation:
E=[1/(b−3.2)]×47386
Results

In Table I below the results obtained for the aminoresin adhesive of Example 1 are shown.

TABLE 1

| | Maximum modulus of elasticity |
|---|---|
| | (corrected average) |
| | of the adhesive |
| Adjuvant | tested (MPa) |
| Control = Aminoresin | 1989 |
| adhesive of Example 1 without TME | |
| Aminoresin adhesive of Example 1 | 2305 |

In Table II below the results obtained for the phenolic resin adhesive of Example 2 are given.

TABLE II

| | Maximum modulus of elasticity |
|---|---|
| | (corrected average) |
| | of the adhesive |
| Adjuvant | tested (MPa) |
| Control = Phenolic resin | 3729 |
| adhesive of Example 2 without TME | |
| Phenolic resin adhesive of Example 2 | 4652 |

The results which appear in Tables I and II clearly show the effect of TME on the modulus of elasticity measured and, consequently on the increase in the mechanical strength obtained.

2) Measurement of Tensile Strength on Particle Boards

a) Preparation of the Boards

To 1000 g of dry wood the quantities of the various constituents, shown in grams in Table III below, were added.

TABLE III

| | Sample No. | | | |
|---|---|---|---|---|
| | 1 | 2 | 3 | 4 |
| Dry wood | 1000 | 1000 | 1000 | 1000 |
| Aminoresin adhesive of Example 1 | 100 | 100 | | |
| without TME | | | | |
| Aminoresin adhesive of Example 1 | | | 100 | 100 |
| without melamine and without TME | | | | |
| TME | | 10 | | 10 |

The boards were pressed at a surface temperature of 190° C., at a maximum pressure of 28 kg/cm², with a pressing cycle of 3 minutes, for a final board thickness of 14 mm (pressing time 12.8 sec/mm).

b) Results

On the boards obtained in this way, tensile strength measurements were carried out using the method described in the European Standard EN 319. The results obtained are given in Table IV below.

TABLE IV

| | Tensile |
|---|---|
| No. of samples | strength |
| Aminoresin adhesive of Example 1 | 0.858 |
| without TME | |
| Aminoresin adhesive of Example 1 | 0.966 |
| Aminoresin adhesive of Example 1 | 1.077 |
| without melamine and without TME | |
| Aminoresin adhesive of Example 1 | 1.227 |
| without melamine | |

These results firstly show that, all the other parameters being identical, the tensile strength obtained is clearly improved for the samples with TME compared to the controls (samples without TME). The addition of TME therefore allows the quantity of adhesive to be reduced while maintaining a comparable tensile strength. The present invention thus allows a reduction in the cost of the boards produced to be obtained, and in particular a decrease in formaldehyde emissions, both during the production and during the ageing of the boards. Moreover, since the melamine is introduced into the urea-formaldehyde adhesives in order to increase their mechanical strength, the presence of TME therefore allows a reduction in the quantity of melamine necessary for an equivalent mechanical strength, which also contributes to a reduction in the price of the adhesives and the boards produced with these. Finally, it is also necessary to point out that the presence of TME in an aminoresin or phenolic resin adhesive increases its water compatibility. After its production, the degree of polymerization of an adhesive increases over time; the adhesive is then said to be more “advanced”, which results in an increase in the reaction rate of said adhesive when it is used. However, the more an adhesive is polymerized the greater its water compatibility and therefore the lower its dilutability. The fact that the presence of TME in an adhesive increases its water compatibility therefore has a twofold consequence, namely, that on the one hand, for the same degree of polymerization, the water compatibility is increased and, on the other hand, for the same water compatibility, the degree of polymerization, therefore the reaction rate during use, can also be increased.

### EXAMPLE 3

### Preparation of an Adhesive of the Aminoresin Type without Formaldehyde

An aminoresin adhesive without formaldehyde according to the invention was prepared as follows:

126 parts of melamine, 520 parts of an aqueous solution dimethoxyethanal (DME) at 60% and 164 parts of water are introduced into a reactor equipped with a condenser, a thermometer and a pH meter.

The pH is adjusted to a value of approximately 5.8 by the addition of sulphuric acid at 20%.

The reaction is maintained at 95° C. for 3.5 hours under continuous stirring.

Then 4.8 parts of urea are added then the mixture is cooled down slowly over 2 hours to ambient temperature.

Then 5.1 mg of TME and 7.9 mg of (NH₄)₂SO₄ in aqueous solution at 20% are added to 67 mg of the aminoresin adhesive without formaldehyde as above in order to obtain an adhesive according to the invention.

### EXAMPLE 4

### Preparation of an Adhesive of the Aminoresin Type without Formaldehyde

The method is carried out as in Example 3, but replacing the TME with 1,1,3,3-tetramethoxypropane (TMP) (Acros catalogue).

### EXAMPLE 5

### Preparation of an Adhesive of the Aminoresin Type without Formaldehyde

The method is carried out as in Example 3, but replacing the TME with 1,1,3,3-tetraethoxypropane (TEP) (Acros catalogue).

Mechanical Tests

Dynamic Mechanical Thermal Analysis (DMTA)

Two small panels of beech wood were assembled using the different samples of adhesive to be analyzed from Examples 3, 4 and 5 as well as with the controls below:

TABLE V

| | Aminoresin adhesive | Hardener ((NH₄)₂S0₄) |
|---|---|---|
| | without formaldehyde of | (aqueous solution at |
| Sample | Example 3 (mg) | 20%) (mg) |
| 1 (control) | 80 | |
| 2 (control + | 75.2 | 4.8 |
| hardener) | | |

Operating Protocol

40 mg of adhesive mixture is placed on each small panel of beech wood (38×8×0.5 mm) then a sandwich of small panels of beech wood is formed by assembling two small panels, the assembly thus obtained is arranged on a support and the whole is placed in an oven.

The oven is subjected to a program of increasing the temperature from 40 to 250° C., at a rate of 4° C./minute. The force applied is 0.3 N, the frequency is 1 Hz and the deformation (strain) is 0.

The apparatus used in this experiment is a Rheometric Scientific DMTA MkIII, with 3-point bending.

Results

In Table VI below the results obtained for the samples indicated are shown.

TABLE VI

| | Maximum modulus |
|---|---|
| Sample | of elasticity (MPa) |
| 1 (control) | 4810 |
| 2 (control + hardener) | 4330 |
| Adhesive of Example 3 | 5480 |
| Adhesive of Example 4 | 6030 |
| Adhesive of Example 5 | 5360 |

The results shown in Table VI clearly demonstrate the effect of the acetals on the modulus of elasticity measured, and consequently on the increase in the mechanical strength obtained.

### EXAMPLE 6

### Preparation of an Adhesive of the Phenolic Resin Type

A phenolic resin adhesive (phenol-formaldehyde) according to the invention was prepared as follows:

400 g of phenol at 92% and 22 g of potash at 50% are incorporated in a reactor with magnetic stirring and heating by oil bath. After having taken the mixture to 50° C., 282 g of formaldehyde at 50% is added dropwise, then the mixture is heated at 85° C. for approximately 1 hour. At 85° C., the condensation stage is started and the synthesis is stopped when the mass dilutability (water tolerance) is 40 g of water for 10 g of resin. Finally the mixture is cooled down to 50° C. over approximately 30 minutes and the pH is adjusted to around 7 at 20° C. by adding HCl at 20%.

a) Tests

Development of Viscosity

Using a Brookfield LV++ viscometer and following the standard NF T76-102, the influence of the addition of TME on viscosity was measured.

In order to do this, the mixtures were produced just before use, under the following operating conditions:
Mobile S00
Speed 5 rpm
Temperature 20° C.
   Development of Surface Tension

The influence of the addition of TME on surface tension was measured according to the method described in ISO standard 4311 using a Wilhelmy balance.

The mixtures are produced just before use and taking the average of 3 readings for each % of TME.

Development of Dilutability (Water Tolerance WT)

This is carried out by determining the quantity of water required in order to produce an irreversible turbidity even after 30 seconds of stirring the water/resin mixture:
WT=mass of water added/resin mass

Development of Paper Penetration

The influence of the addition of TME on paper penetration was measured according to the method described in the standard NF Q03-069.

The apparatus consists of two receptacles connected by a flexible tube, one fixed, the other mobile, allowing, when it is moved, a given water pressure in the test tube fixed to the first receptacle to be ensured: this water pressure allows the liquid to be forced to pass through the paper, but the time which the first drop takes to pass through the paper is variable and a function of the resistance of the paper to penetration.

Kraft paper of 180 g/m² is used and 2 values are taken for each test:
The time required to notice a completely round area on the paper, representing the fact that all of the resin/paper contact surface has been impregnated,
The time required to obtain a properly formed drop on the surface.

Results

The results obtained are given in Table VII below.

TABLEAU VII

| | | | Surface | | Circle | Time for |
|---|---|---|---|---|---|---|
| | % | Viscosity | tension | Dilut- | formation | first |
| Sample | TME | (mPa · s) | (mJ · m⁻²) | ability | time (s) | drop (s) |
| 1 | 0 | 55 | 55.4 | 0.8 | 20 | 217 |
| 2 | 5 | 43 | 46.7 | 1.0 | 10 | 157 |
| 3 | 10 | 42 | 42.0 | 1.2 | 6 | 147 |
| 4 | 15 | — | 41.2 | — | — | — |
| 5 | 20 | 40 | 40.6 | 1.6 | — | — |
| 6 | 30 | 38 | 39.9 | — | 4 | 110 |

These results show that:
The addition of TME lowers the viscosity, which is an advantageous factor for facilitating the use of the adhesive,
The addition of TME rapidly lowers the surface tension of the PF resin and this occurs very rapidly as soon as a few % are added, which favourably influences the spreading of the adhesive on the support (for example paper) but also its ability to penetrate the volume of pores and be distributed there in a homogeneous manner,
The addition of TME increases the dilutability, which indicates better compatibility between the PF resin and the water as well as better stability,
The results obtained for paper penetration are in agreement with the decrease in viscosity and surface tension, which are factors favouring impregnation.

1. An adhesive with high mechanical strength, characterized in that it contains a diacetal which is linear or cyclic, being able to be prepared from C₂-C₆ aldehydes and C₁-C₁₂ alcohols.

2. An adhesive according to claim 1, characterized in that it contains a diacetal prepared from C₂-C₄ aldehydes and C₁-C₈ alcohols.

3. An adhesive according to claim 1, characterized in that it contains a diacetal prepared from C₂-C₃ aldehydes and C₁-C₃ alcohols.

4. An adhesive according to claim 1, characterized in that it contains a diacetal selected from the group consisting of 1,1,2,2-tetramethoxyethane, 1,1,2,2-tetraethoxyethane, 1,1,2,2,-tetrapropoxyethane, 1,1,3,3-tetramethoxypropane and 1,1,3,3-tetraethoxypropane.

5. An adhesive according to claim 1, characterized in that it contains 1,1,2,2-tetramethoxyethane.

6. An adhesive according to claim 1, characterized in that it contains any combination of two or three diacetals.

7. An adhesive according to claim 1, characterized in that it is an aminoresin adhesive, particularly of the melamine-urea-formaldehyde type.

8. An adhesive according to claim 1, characterized in that it is a phenolic resin adhesive, particularly of the phenol-formaldehyde type.

9. An adhesive according to claim 1, characterized in that it is an aminoresin, phenolic resin or resorcinol adhesive, with or without formaldehyde.

10. An adhesive according to claim 1, which is an aminoresin adhesive, characterized in that it is based on a nitrogen compound/formaldehyde mixture in proportions of 1/0.2 to 3.

11. An adhesive according to claim 1, which is a phenolic resin adhesive, characterized in that it is based on a phenol/formaldehyde mixture in proportions of 1/0.7 to 2.8.

12. An adhesive according to claim 1, characterized in that the diacetal or diacetals represent 1.7 to 25% by weight of all of the constituents of the adhesive.

13. Agricultural waste or a wood composition such as fibreboards, particle boards, oriented strand boards or OSB, Medium and High Density Fibreboards or MDF), and other types of similar boards and plywoods containing an adhesive as defined in claim 1 or prepared using such an adhesive.

14. A paper or laminated board containing a resin or adhesive as defined in claim 1 or prepared using a resin or adhesive as above, or a product prepared using such papers or laminated boards.

15. A method for the gluing of fibres in which fibres are glued using an adhesive as defined in claim 1.

16. An adhesive according to claim 1, characterized in that it contains any combination of two or three diacetals selected from the group consisting of 1,1,2,2-tetramethoxyethane, 1,1,2,2-tetraethoxyethane, 1,1,2,2-tetrapropoxyethane, 1,1,3,3-tetramethoxypropane, and 1,1,3,3-tetraethoxypropane.

17. An adhesive according to claim 1, characterized in that it contains a diacetal or diacetals selected from the group consisting of 1,1,2,2-tetramethoxyethane, 1,1,2,2-tetraethoxyethane, 1,1,2,2-tetrapropoxyethane, 1,1,3,3-tetramethoxypropane and 1,1,3,3-tetraethoxypropane, in an amount of 1.7 to 25% by weight of all constituents.

18. Agricultural waste or wood composition according to claim 13, characterized in that it contains an adhesive containing a diacetal selected from the group consisting of 1,1,2,2-tetramethoxyethane, 1,1,2,2-tetraethoxyethane, 1,1,2,2-tetrapropoxyethane, 1,1,3,3-tetramethoxypropane and 1,1,3,3-tetraethoxypropane, or prepared using such an adhesive.

19. A paper or laminated board according to claim 14, characterized in that it contains an adhesive containing a diacetal selected from the group consisting of 1,1,2,2-tetramethoxyethane, 1,1,2,2-tetraethoxyethane, 1,1,2,2-tetrapropoxyethane, 1,1,3,3-tetramethoxypropane and 1,1,3,3-tetraethoxypropane, or prepared using such an adhesive.

20. A method according to claim 15, characterized in that the adhesive contains a diacetal selected from the group consisting of 1,1,2,2-tetramethoxyethane, 1,1,2,2-tetraethoxyethane, 1,1,2,2-tetrapropoxyethane, 1,1,3,3-tetramethoxypropane and 1,1,3,3-tetraethoxypropane.
